(19) United States
(12) Patent Application Publication
(10) Pub. No.: US 2003/0134123 A1
(43) Pub. Date: Jul. 17, 2003

(54) Multilayer polymeric film having unsealed portions with controlled shape

(75) Inventor: Anthony Morton Paine, Manningtree (GB)

Correspondence Address: N. Whitney Wilson, BRYAN CAVE LLP, 245 Park Avenue, New York, NY, 10167-0034, US

(73) Assignee: MOPLEFAN (U.K) LIMITED.

(21) Appl. No.: 10/350,741

(22) Filed: Jan. 24, 2003

Related U.S. Application Data
(62) Division of application No. 09/600,942, filed on Nov. 14, 2000.
Application No. 09/600,942 is a 371 of international application No. PCT/EP99/08875, filed on Nov. 18, 1999.

(30) Foreign Application Priority Data
Nov. 24, 1998 (GB) 9825744.7

(51) Int. Cl. B32B 9/04; B32B 3/00

(52) U.S. Cl. 428/411.1; 156/244.11

(57) ABSTRACT

Bi- or multilayer polymeric films comprising portions of controlled shape wherein at least two adjacent layers are unsealed, said portions being visually distinct from the background constituted by other portions of the film, where preferably all the layers are sealed to each other and process for preparing the same.

The present invention relates to bi- or multilayer films of plastic (in particular polyolefin) materials, containing portions of controlled shape, area, number and arrangement, wherein at least two adjacent layers are unsealed (i.e. not sealed to each other), and to a process for producing them.

Such films constitute a new class of materials, particularly fit for use in fields where the visual perception of regular and defined designs (like decorative patterns, words, logos) is desirable, such as for instance in packaging, laminated items, banknotes. In fact the unsealed portions, normally including air, are visually distinct from the background constituted by the rest of the film, where all the layers are sealed to each other.

The closest materials in the prior art are the so called “cellular” or “corrugated” sheets, obtained by laminating to each other films or sheets of thermoplastic polymers.

As the purpose of such materials is to achieve a cushioning effect in packaging applications and/or an improvement in mechanical properties, such as rigidity and impact resistance, they contain cells or patterns having a substantive thickness, largely exceeding the total thickness of the superimposed layers, so that they substantially differ in shape and thickness from a multilayer film.

The processes for preparing such cellular or corrugated sheets comprise the separate preparation of flat layers and a lamination step where the layers are sealed to each other by way of means capable of producing cells or corrugations having substantive thickness, like embossing rolls.

Examples of this kind of processes and of the materials obtainable from them are disclosed in published patent applications EP 166 312, EP 399 965 and WO 96/01185.

In addition to the said substantial differences in terms of properties and size of the obtained materials, such prior-art processes are incapable of providing oriented materials and therefore they cannot achieve, particularly in the case of polypropylene materials, the remarkable improvement of mechanical properties deriving from molecular orientation.

Therefore the present invention provides bi- or multilayer polymeric films, preferably oriented, in particular mono- or bi-axially oriented, comprising portions of controlled shape wherein at least two adjacent layers are unsealed (unsealed portions), said portions being visually distinct from the background constituted by other portions of the film, where preferably all the layers are sealed to each other.

In particular, the present invention provides bi- or multilayer polymeric films, preferably oriented, in particular mono- or bi-axially oriented, comprising portions of controlled shape wherein at least two adjacent layers are unsealed (unsealed portions), said portions being visually distinct from the background constitued by the rest of the film, where all the layers are sealed to each other.

For “controlled shape” it is meant that the shape of the unsealed portions, as delimited by their contours, is regular, as opposed to the irregular and random shape of defects of sealing possibly occurring when the film-production process is incorrectly run.

For “visually distinct” it is meant that such unsealed portions are detectable by the human eye and appear distinguished from the said background when looking at the surface of the films or looking through them.

As previously mentioned, such effect is for instance achieved when a thin layer of gas, in particular air, is entrapped in the unsealed portions.

A further advantage of the films of the present invention is that they retain the advantageous optical properties typically achievable by the blown-bubble extrusion process (mainly through a proper control of the rate of cooling of the film), at least in the background portion. Also the mechanical properties typical for films obtained by the said blown-bubble extrusion process can be easily retained in the films of the present invention.

Preferred features for the films of the present invention are (taken singly or in whichever combination):

a total thickness in the background portion from 12 to 100 μm, more preferably from 20 to 75 μm;

an additional thickness in the unsealed portions from 0.01 to 4 μm;

a thickness of single layers from 0.1 to 50 μm, more preferably from 0.5 to 40 μm;

a number of layers of from 2 to 10, more preferably from 2 to 6;

a percentage of the overall area of the unsealed portions with respect to the total area of the film of from 0.1 to 75%, more preferably from 1 to 30%;

a stretch ratio for bi-axially oriented polypropylene films from 3 to 12, more preferably from 4.5 to 8, in both directions (namely MD, i.e. Machine Direction, and TD, i.e. Transverse Direction), while for other oriented films (for example of PET, PVC, LLDPE, PA) stretch ratios could be different and are well known in the art;

a blow up ratio for non oriented films from about 3 to about 8;

a Gardiner haze for bi-axially oriented polypropylene films (according to standard ASTM D 1003) from 2 to 6 units (unsealed portions may have a haze value up to 0.5 units higher than sealed portions);

a 60 degree gloss for bi-axially oriented polypropylene films(according to standard ASTM D 2457) from 120 to 145 units;

a tensile strength for bi-axially oriented polypropylene films (both MD and TD ASTM D 882) from 180 to 200 N/mm².

Whenever the term “area” is used, an area measured on whichever of the two faces (surfaces) of the film is meant.

Shape, spacing and arrangement of the unsealed portions are not critical and can be largely dictated by aesthetic criteria, depending upon the desired subject to be represented by the unsealed portions, singly or in combination (for instance words, scripts, logos, patterns, watermark-like drawings).

The layers constituting the films of the present invention can be made of or comprise any thermoplastic or elastomeric polymer capable of being sealed in a bi- or multilayer assembly under temperature and pressure conditions advantageously employable in the industrial practice. Preferably at least one layer is made of or comprises one or more olefin polymers, for instance polyethylene (HDPE, LDPE, LLDPE), low temperature sealing polymers, such as ethylene/vinyl acetate, ethylene/butyl acrylate or ethylene/methyl methacrylate copolymers, vinylidene polymers or copolymers, crystalline and isotactic olefin polymers, elastomeric or elastomeric-thermoplastic olefin polymers or blends of the such polymers.

In particular, at least one layer can be made of or comprise one or more homopolymers or copolymers, or their mixtures, of R—CH═CH₂ olefins where R is hydrogen or a C₁-C₆ alkyl or an aryl radical. Particularly preferred are the following polymers:

i) isotactic or mainly isotactic propylene homopolymers;

ii) random copolymers of propylene with ethylene and/or C₄-C₈ α-olefins, such as for example 1-butene, 1-hexene, 1-octene, 4-methyl-1-pentene, wherein the total comonomer content ranges from 0.05% to 20% by weight, or mixtures of said copolymers with homopolymers i);

iii) heterophasic copolymers comprising (a) a propylene homopolymer and/or a random copolymer ii), and an elastomeric fraction (b) comprising one or more copolymers of ethylene with propylene and/or a C₄-C₈ 60 -olefin, optionally containing minor amounts of a diene, such as butadiene, 1,4-hexadiene, 1,5-hexadiene, 5-ethylidene-2-norbomene.

Preferably the amount of diene in (b) is from 1% to 10% by weight.

The heterophasic copolymers iii) are prepared according to known methods by mixing the components in the molten state, or by sequential copolymerization, and generally contain the copolymer fraction (b) in amounts ranging from 5% to 80% by weight.

Examples of polymeric materials different from polyolefin, employable for the layers of the films of the present invention, are polyvinylchlorides, polyamides, polyesters and polycarbonates.

In order to achieve an easy sealability between the layers, it is preferred to include in the multilayer structure a sufficient number of heat-sealable layers made of or comprising heat-sealable polymers with low sealing temperature and good seal strength (the latter being measured in terms of load or force to be applied to open the seal).

Such polymers are well known in the art; for instance, in the case of polyolefins, they can be selected among the above mentioned low temperature sealing polymers and the said random propylene copolymers ii) with a comonomer content high enough to achieve the said seal features (indicatively, not less than 5% by weight of the said comonomers with respect to the total weight of the copolymer).

When two or more layers are not easily sealable, it is convenient to alternate each of them with at least one of the said heat-sealable layers.

The polymer layers may comprise additives commonly employed in the art, like stabilisers, pigments, fillers, nucleating agents, slip agents, lubricant and antistatic agents, flame retardants, plasticizers and biocidal agents.

As a further object, the present invention provides a process for producing the said bi- or multilayer polymeric films, said process comprising the steps of superimposing two or more layers, for instance by superimposing two mono- or multilayer webs, and locally sealing the superimposed layers by passing them through a pair of rolls (sealing nip rolls), at least one of which has engravings on its surface, such engravings having the same shape as the unsealed portions to be obtained in the films.

For example, in a flat film process, either cast film or stenter, the web can be slit down in the middle and the two webs thus formed can be superimposed (for instance by guiding them over angled rollers or turner bars) and sealed together.

It is also possible for the process to be carried out as an off line operation, by unwinding the two webs from separate offwinds and sealing them together in a heated nip.

In particular, the present invention provides a blown-bubble extrusion process for producing the said bi- or multilayer polymeric films with unsealed portions having controlled shape, said process comprising (A) the formation of a blown bubble of polymer, followed by a collapsing step (B) where the bubble is flattened and superimposed layers are obtained, and a sealing step (C) where the flattened bubble is split by cutting it at the two edges and the superimposed layers are locally sealed by passing them through a pair of rolls (sealing nip rolls), at least one of which has engravings on its surface, such engravings having the same shape as the unsealed portions to be obtained in the films.

The term “engravings” is used here to designate the hollow areas (recesses) resulting from the act of engraving.

As deducible from the previous description, the local sealing defines the background, portions of the films and is obtained in correspondence to the surfaces of the sealing nip rolls wherein no engravings are present, while the engravings correspond to and define the unsealed portions of the films.

The size of the unsealed portions substantially corresponds to the size of the engravings. Number and arrangement of the unsealed portions are determined by the arrangement of the engravings in the roll or rolls.

The blown bubble is obtained by conventional techniques, by blowing with a gas, in particular with air, a tubular polymer melt obtained by extrusion through an annular die.

Such die is preferably a co-extrusion die, to enable production of multilayer films.

In a preferred embodiment of the invention, the inner layer of the tubular polymer melt and, consequently, of the bubble, is made of or comprises one or more of the previously said heat-sealable polymers.

The gas used for blowing is trapped in the bubble by the die at one end and by a pair of nip rolls (main nip rolls) at the other.

The bubble is collapsed (flattened) by passing it through the said main nip rolls.

Before the main nip rolls the bubble is preferably passed through converging means, for example trains of rolls, slats or air cushions.

After coming out of the die and while being blown, the polymer melt is generally cooled by way of appropriate cooling means, such as air or water cooling rings.

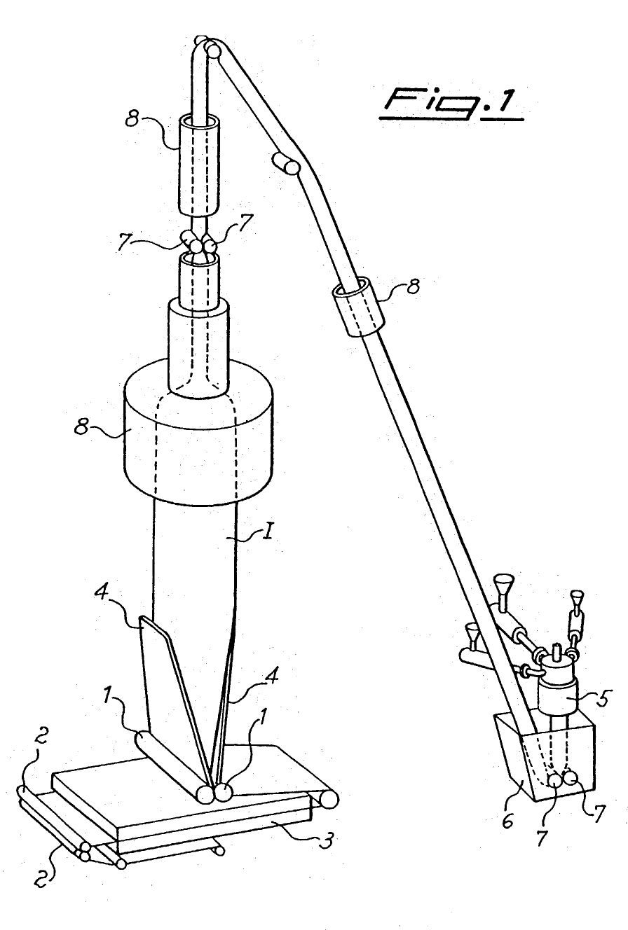

According to an alternative and preferred embodiment, which is illustrated in annexed FIG. 1, the said tubular polymer melt, after coming out of the extrusion die 5, is quenched with an appropriate quench system (for instance a water quench system 6), where it is cooled to a temperature under the melting point of the polymer material in form of a tube that can be transported over rolls to subsequent parts of the process. The temperature at which the tube is kept is preferably from 10 to 65° C., more preferably from 20 to 30° C.

This quenched tube subsequently passes through one or more pairs of nip rolls 7 which control the speed of the tube. Because the rate of extrusion and the diameter of the tube have previously been controlled, the speed of the last pair of nip rolls also controls the tube thickness.

During and/or subsequent to running through the last of the said nip rolls, the tube is preheated to a temperature at which it is ductile (using for instance infra-red heaters 8 placed before and/or after the said nip rolls) and blown to form a bubble I which is then collapsed, both blowing and collapsing steps being carried out as previously described.

Blowing is achieved by introducing a large volume of gas (in particular air) into the tubular plastic melt exiting the annular die or into the preheated tube.

As previously said, the bubble is collapsed by passing it through a couple of main nip rolls 1 that restrict loss of gas from the bubble, preferably preceded by converging means 4.

Moreover these rolls are preferably set to run at a faster speed with respect to the polymer feeding speed (determined by the nip rolls conveying the tube, when a quenched tube is produced), so that the polymer, as well as being stretched in the Transverse Direction by the air in the bubble, is simultaneously stretched in the Machine Direction.

As the polymer emerges from the main nip rolls, it is in the form of a collapsed tube, commonly called “layflat tube”.

The speed of the main nip rolls and the width of the layflat tube determine the film thickness at this point.

When the layflat tube retains stresses (generally caused by chain to chain distortions that have not exceeded the limit of elastic distortion), they should be reduced in order to flatten the tube and, consequently, the film.

This can be done in an annealing section 3, installed after the main nip rolls.

The annealing section can for instance consist of an air oven, where the layflat tube is contacted with hot air at such a temperature as to induce a small degree of film shrinkage.

The hot air temperatures are generally from 100 to 180° C., more preferably from 120 to 160° C., while illustrative film shrinkages are in the order of from 2 to 4% MD and 1 to 3% TD at 120° C.

It is also possible to carry out the annealing step by using a stenter equipment or running the film over a series, of heated rolls.

Complete shrinkage is prevented by maintaining suitable temperatures and applying suitable tension in the layflat tube both in the Machine and in the Transverse direction.

In the Machine Direction, the said tension can be controlled by adjusting the speed differential between the sealing nip rolls and the main nip rolls.

In the Transverse Direction, the tension can be applied by threading the layflat tube over a pair of rods running in the machine direction along each side of the annealing section.

Preferably, the rods taper inwards to allow the correct amount of transverse shrinkage to occur without film snagging and breaking. To assist in running the layflat tube over the rods at high temperature, a gas (air) supply is preferably fed to the outer edge of the rods to lubricate the contact with the fold (i.e. the two edges) of the layflat tube. It is believed that this gas supply might also have the effect of favouring the formation of a thin gas layer in the unsealed portions of the films.

Before being fed to the sealing nip rolls, the layflat tube is split by cutting it at the two edges i.e. at the two lines where the layflat tube folds.

This can be achieved by fixing the said rods to points outside the tube, so immediately before the mounting points, the tube is slit into webs.

After splitting the layflat tube, the so obtained superimposed layers are heat-sealed to obtain the bi- or multilayer film.

The sealing step is carried out simultaneously as the two webs are brought together.

According to an alternative embodiment, when stenter equipment is used for the annealing step, the two webs are obtained by cutting the layflat tube before annealing. Also, when using stenter equipment, the sealing step can be carried out either before or after annealing.

As previously said, heat-sealing is achieved by passing the superimposed layers through a couple of sealing nip rolls 2.

According to an alternative embodiment, both the said collapsing step (B) and sealing step (C) can be carried out by means of the main nip rolls, which in this case coincide with the sealing nip rolls in terms of function and features.

There are two principal and equally preferred constructional alternatives for the sealing nip rolls making up the sealing nip.

According to one of these alternatives, one of these sealing nip rolls has a smooth surface (non-engraved roll) and is heated at the required sealing temperature while the other is engraved. If, for instance, a propylene copolymer or terpolymer is used as heat-sealable polymer, the sealing temperature is preferably in the-range of 95 to 140° C., more preferably 105 to 125° C.; if other heat-sealable polymers, such as LDPE or blends of LDPE with EVA, EBA or EMA are used, the sealing temperature is lower.

The non-engraved roll is preferably made of metal (in particular of steel) and can be heated for instance by way of internal electrical resistances, internally flowing heating fluids or inductive coupling. Alternatively, heat input could be from an external source.

The engraved roll is preferably made of metal (in particular of steel) as well, but covered with a layer of polymeric material, in particular of rubber, containing the engravings.

The hardness of the polymeric material should be such that it does not distort significantly under the nip pressures applied. Preferably, the hardness should range from 50 to 100 on the International Rubber Hardness Durometer Scale (I R H D), more preferably from 65 to 90.

Specific examples of polymeric materials that can be used for the engraved roll are Hypalon chlorosulfonated polyethylene, polybutadiene, natural rubber, EPDM, styrene/butadiene copolymer, chloroprene, silicone rubber, nitrile rubber, polyurethane, styrene rubber, carboxylated nitrite rubber and Viton fluoroelastomers.

The rubber thickness should be preferably 1 to 50 mm, more preferably 4 to 15 mm.

The depth of the engravings is such that heat sealing does not occur in their correspondence.

Preferably, the depth of the engravings should be in the range of from 0.1 to 5 mm, more preferably from 0.5 to 2 mm.

The nip pressure should be preferably in the range of from 0.5 to 2.5 kg per linear cm, more preferably from 1 to 1.5 kg per linear cm.

According to the other preferred alternative, one of the said sealing rolls has an engraved surface and is heated to the required sealing temperature, while the other has a smooth, non engraved surface. The required sealing temperature is similar or identical to that used with the previous alternative.

In this case, the engraved roll is preferably made of metal (in particular of steel). When it is of steel, it can be electro-plated and/or electrodeless plated or otherwise coated with other metal or metals (preferably copper, nickel or chromium, or combinations thereof) or with other heat conductive materials.

The engraved roll is, for instance, heated by way of internal electrical resistances, internally flowing fluids or inductive coupling. Alternatively, heat input could be from an external source.

The depth of the engravings is such that heat sealing does not occur in their correspondance.

Preferably the depth of the engravings should be in the range of 0.1 to 5 mm, more preferably from 0.1 to 1 mm.

The smooth roll is preferably made of metal (in particular steel) as well but is covered with a layer of polymeric material, in particular rubber. The hardness of this polymeric material should range from 30 to 100 in the International Rubber Hardness Durometer Scale (I R H D), more preferably from 50 to 90.

Thickness and specific examples of polymeric materials that can be used for the smooth roll are the same as those given for the first alternative. Also the nip pressure should preferably be in the same ranges as in the first alternative.

After coming out of the sealing rolls, the film can be subjected to finishing treatments, like corona discharge treatments, for example.

The so obtained film can be coupled by lamination to other mono-, bi- or multilayer plastic films or to other materials, like paper or metal foils.

Coupling can be effected by laying adhesives onto the appropriate surfaces and using conventional lamination equipment.

The following example is given for illustrative purposes and does not limit the invention itself.

### EXAMPLE

Using a blown-bubble extrusion apparatus as described above with reference to FIG. 1, films according to the invention are produced.

In detail, a tube composed of 3 layers is produced by extrusion through a co-extrusion die and cooling in a water quench system, then the tube is heated and blown and the so obtained bubble is collapsed by passing it through a couple of main nip rolls. The layflat tube so obtained is annealed by means of an air oven, split by cutting it at the two edges and the resulting superimposed layers are heat-sealed through a couple of sealing nip rolls having the previously described features (namely, a heated non-engraved roll of steel and a roll of steel covered with an engraved layer of rubber).

The film layers are produced by co-extruding the following polymeric materials:

Inner layer: propylene terpolymer Adsyl 5 C30 F (Montell) having a Melt Flow Rate, according to standard ISO 1133, of 5.5 g/10 min. and a density, according to standard ISO 1183/A of 0.89 g/cm³.Core layer: propylene homopolymer KF 6100 (Montell), having a Melt Flow Rate, according to standard ISO 1133, of 3 g/10 min.;

Outer layer: propylene homopolymer RF 6100 (Montell), having a Melt Flow Rate, according to standard ISO 1133, of 8 g/10 min. or, in alternative, propylene copolymer Moplen EP 3 C 39 F (Montell), having a Melt Flow Rate of 5 g/10 min. and a density, according to standard ISO 1183, of 0.9 g/cm³.

The following working conditions are used:

| | | |
|---|---|---|
| Inner Extruder | output | 18 Kg/hr |
| | melt temperature | 230° C. |
| Core Extruder | output | 124 Kg/hr |
| | melt temperature | 230° C. |
| Outer Extruder | output | 18 Kg/hr |
| | melt temperature | 230° C. |
| Quench | water temperature | 25° C. |
| | speed | 11.0 m/min. |
| | diameter | 165 mm |
| Bubble | main nip speed | 69.5 m/min. |
| | layflat width | 1600 mm |
| | TD draw ratio | 6.2 |
| | MD draw ratio | 6.3 |
| | draw temperature | 170° C. |
| Annealing | width reduction | 100 mm |
| | speed reduction | 4 m/min. |
| | air temperature | 155° C. |
| Sealing | roll temperature | 125° C. |

The thickness of the single layers results to be:

| | |
|---|---|
| Core layer | 11.6 μm |
| Inner layer | 1.7 μm |

The total thickness of each of the two webs before sealing is about 15 μm.

The total thickness of the film after sealing the two webs is about 30 μm.

Depending upon the kind of engravings present in the engraved roll, films comprising unsealed portions of various shape, extension and arrangement are obtained, with properties falling within the previously reported ranges.

1. Bi- or multilayer polymeric films comprising portions of controlled shape wherein at least two adjacent layers are unsealed, said portions being visually distinct from the background constituted by other portions of the film, where preferably all the layers are sealed to each other.

2. The film of claim 1, having a thickness in the background portion of from 12 to 100 μm and an additional thickness in the unsealed portions of from 0.01 to 4 μm.

3. The film of claims 1 and 2, wherein the percentage of the overall area of the unsealed portions with respect to the total area of the film is from 0.1 to 75%.

4. The film of claims 1 and 2, wherein the unsealed portions are in the form of words, scripts, logos, patterns or watermark-like drawings.

5. The film of claims 1 and 2, wherein the number of layers is from 2 to 10.

6. The film of claim 1, wherein at least one layer is made of or comprises one or more olefin polymers.

7. The film of claim 6, wherein at least one layer is made of or comprises one or more homopolymers or copolymers, or their mixtures, of R—CH═CH₂ olefins where R is hydrogen or a C₁-C₆ alkyl or an aryl radical.

8. Laminated articles comprising the film of claim 1.

9. A process for producing the film of claim 1, said process comprising the steps of superimposing two or more layers and locally sealing the superimposed layers by passing them through a pair of sealing nip rolls, at least one of which has engravings on its surface, such engravings having the same shape as the unsealed portions to be obtained in the films.

10. A blown-bubble extrusion process according to claim 9, said process comprising (A) the formation of a blown bubble of polymer, followed by a collapsing step (B) where the bubble is flattened and superimposed layers are obtained, and a sealing step (C) where the flattened bubble is split by cutting it at the two edges and the superimposed layers are locally sealed.

11. The process of claim 10, wherein the collapsing step (B) is carried out by passing the bubble through a couple of main nip rolls.

12. The process of claims 10 and 11, wherein both the collapsing step (B) and the sealing step (C) are carried out by passing the bubble through a couple of main nip rolls.

13. A flat film process according to claim 9, wherein the web is slit down in the middle and the two webs thus formed are superimposed and sealed together.

14. An off line process according to claim 9, wherein two webs are unwinded from separate offwinds and, sealed together in a heated nip.
